(19) United States
(12) Patent Application Publication
(10) Pub. No.: US 2025/0058613 A1
(43) Pub. Date: Feb. 20, 2025

(54) Embedded car cover

(71) Applicant: Suzhou Maisichuang Automotive Technology Co., Ltd., Suzhou City (CN)

(72) Inventors: Shaoyong Zheng, Suzhou City (CN); Jian Sun, Suzhou City (CN)

(21) Appl. No.: 18/396,146

(22) Filed: Dec. 26, 2023

(30) Foreign Application Priority Data
Aug. 16, 2023 (CN) 202311034014.0

(51) Int. Cl. B60J 7/14

(52) U.S. Cl. CPC B60J 7/141

(57) ABSTRACT

The present invention discloses an embedded hard cover including a front bar system, an intermediate rotating shaft system, a rear bar system, a side rail system and a guide rail, the front bar system, intermediate rotating shaft system and rear bar system forming a transverse frame. The present invention ensures the stability of the front bar system by providing fixing holes in the front bar system and connecting the front bar system to the guide rail utilizing the front bar plum nut to pass through the fixing holes.

### TECHNICAL FIELD

This invention is relevant to automotive spare parts, especially an embedded hard cover

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using it to cover the goods inside the hopper.

Most of the existing front bars of the car cover are one-piece structure. Due to the large front bars, the one-piece structure is not only inconvenient for processing, but also has high transport cost, which increases the manufacturing cost.

### ABOUT THE INVENTION

To overcome the shortcomings of the existing technology, the present invention provides an embedded hard cover to solve the problem that the existing front bars are not easy to manufacture and transport.

In order to solve the above problems of the existing technology, the technical solution adopted in the invention is as follows:

An embedded hard cover includes a front bar system, an intermediate rotating shaft system, a rear bar system, a side rail system and a guide rail, the front bar system, the intermediate rotating shaft system and the rear bar system forming a transverse frame, the side rail system forming a longitudinal frame, both the longitudinal frame and the transverse frame are connected to the car body by the guide rail.

The front bar system includes a front bar assembly and a front bar plum nut, the front bar assembly is provided with a fixing hole, the front bar plum nut passes through the fixing hole to connect the front bar assembly with the guide rail.

The stability of the front rail system is ensured by providing the fixing holes in the front rail system and connecting the front bar system to the guide rail by utilizing the front rail plum nut to pass through the fixing holes.

Further, the guide rail includes a blocking surface, the front rail plum nut includes a plum shank and a threaded rod, the threaded rod passes through the fixing holes and tightens against the blocking surface, by providing the blocking surface at the guide rail for tightening the front rail plum nut against it for limiting, it is possible to ensure that sufficient support is provided to the front bar system. The front bar assembly includes a first front bar, a second front bar and a third front bar, both the first front bar and the third front bar are connected to the second front bar, the second front bar is provided with a limiting portion, the fixing holes are provided in the limiting portion, the guide rail is provided with a guide notch, the guide notch is used to pass through the limiting portion, the first front bar is provided with a first gluing surface, the second front bar is provided with a second gluing surface and a third gluing surface, the third front bar is provided with a fourth gluing surface, the first gluing surface is glued to the second gluing surface, the third gluing surface is glued to the fourth gluing surface, by setting the gluing surface, the first front bar, the second front bar and the third front bar are designed as a split structure, which is convenient for transportation and manufacture, after that the first front bar, the second front bar and the third front bar are connected to be an whole, which makes a better stabilization of the whole front bar system, the second front bar is provided with a mounting hole, the limiting portion is provided with a reinforcing bar, the mounting hole is provided for connecting the side joints, the reinforcing bar is provided to increase the strength of the clamping surface.

Further, the intermediate rotating shaft system includes a first intermediate rotating shaft system and a second intermediate rotating shaft system, the first intermediate rotating shaft system and the second intermediate rotating shaft system are of equal width, the first intermediate rotating shaft system includes a first left rod, a first left rubber strip, a first intermediate rod, a first right rubber strip, and a first right rod, the first left rubber strip is arranged between the first left rod and the first intermediate rod, the first right rubber strip is arranged between the first right rod and the first intermediate rod, the second intermediate rotating shaft system includes a second left rod, a second left rubber strip, a second intermediate rod, a second right rubber strip and a second right rod, the second left rubber strip is arranged between the second left rod and the second intermediate rod, the second right rubber strip is arranged between the second right rod and the second intermediate rod. The beneficial effects of the present invention are:

1. The present invention designs the front bar as a split structure to facilitate transportation, and then connects the front bar as a whole to make it have a better stability, and secures the front bar to the guide rail by the front bar plum nut, which reduces the original extension plate structure and reduces the manufacturing cost.

2. The present invention facilitates the installation of the front rail and improves the work efficiency by setting the guide rail notch.

### DESCRIPTION OF DRAWINGS

FIG. 1 is a installation schematic diagram I of the present invention;

FIG. 2 is a installation schematic diagram II of the present invention;

FIG. 3 is a partially enlarged view of part A in FIG. 2;

FIG. 4 is a structure schematic diagram I of the opening of the car cover in the present invention;

FIG. 5 is a partially enlarged view of part B in FIG. 4;

FIG. 6 is a partially enlarged view of part C in FIG. 4;

FIG. 7 is a structure schematic diagram II of the opening of the car cover in the present invention;

FIG. 8 is a structure schematic diagram of the front bar system in the present invention;

FIG. 9 is a partially enlarged view of part D in FIG. 8;

FIG. 10 is a installation schematic diagram III of the present invention.

Figures: 1—Front bar system; 11—First front bar; 1101—First gluing surface; 12—Second front bar; 1201—Fixing holes; 1202—Reinforcing bars; 1203—Mounting holes; 1204—Second gluing surface; 1205—Third gluing surface; 1206—Clamping surface; 1207—Limiting portion; 13—Third front bar; 1301—Fourth gluing surface; 14—Front bar plum nut; 1401—Plum shank; 1402—Threaded rod; 2—First intermediate rotating shaft system; 21—First left rod; 22—First left rubber strip; 23—First intermediate rod; 24—First right rubber strip; 25—First right rod; 3—Second intermediate rotating shaft system; 31—Second left rod; 32—Second left rubber strip; 33—Second intermediate rod; 34—Second right rubber strip; 35—Second right rod; 4—Rear rail system; 5—Side rail system; 6—Guide rail system; 61—Guide rail; 6101—Blocking surface; 6102—Guide rail notch.

### THE CONCRETE METHOD TO CARRY OUT

The following instruction further explains the invention's concrete implementation method.

In order to enable a clearer understanding of the objects mentioned above, features and advantages of the present invention, the invention is described in detail below in connecting with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying drawings. It should be understood that the specific embodiments described herein are intended only to illustrate and explain the present invention and not to limit it.

### Embodiment 1

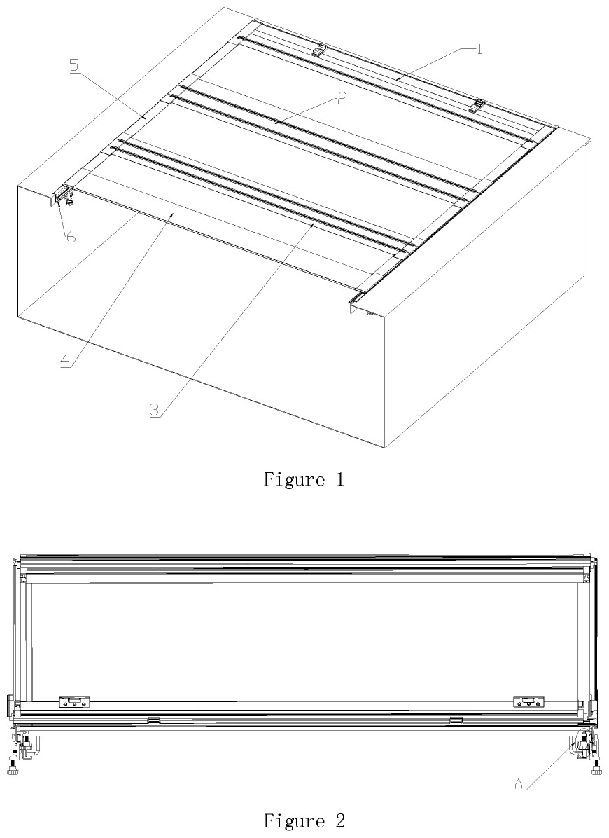

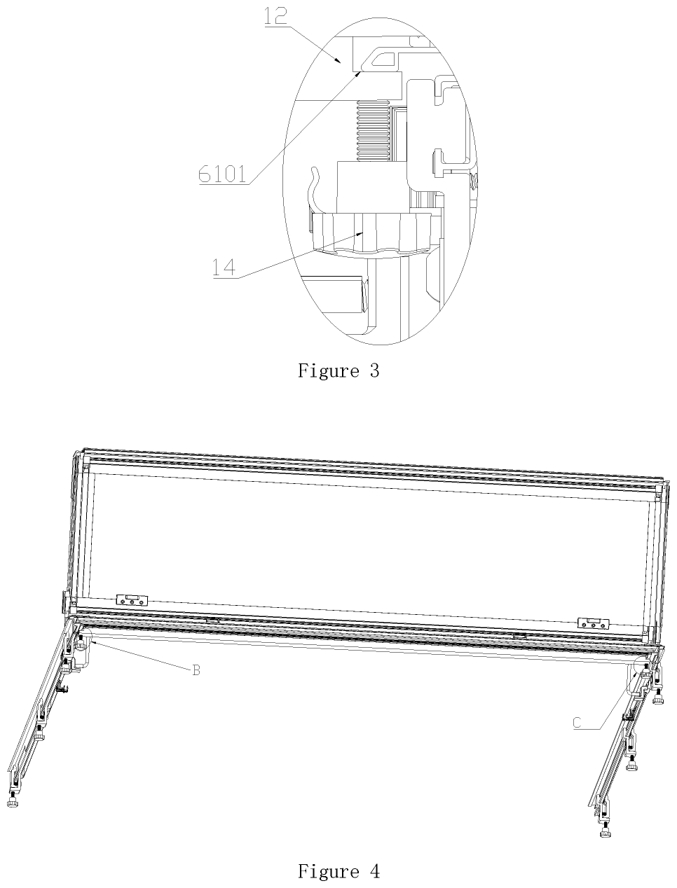

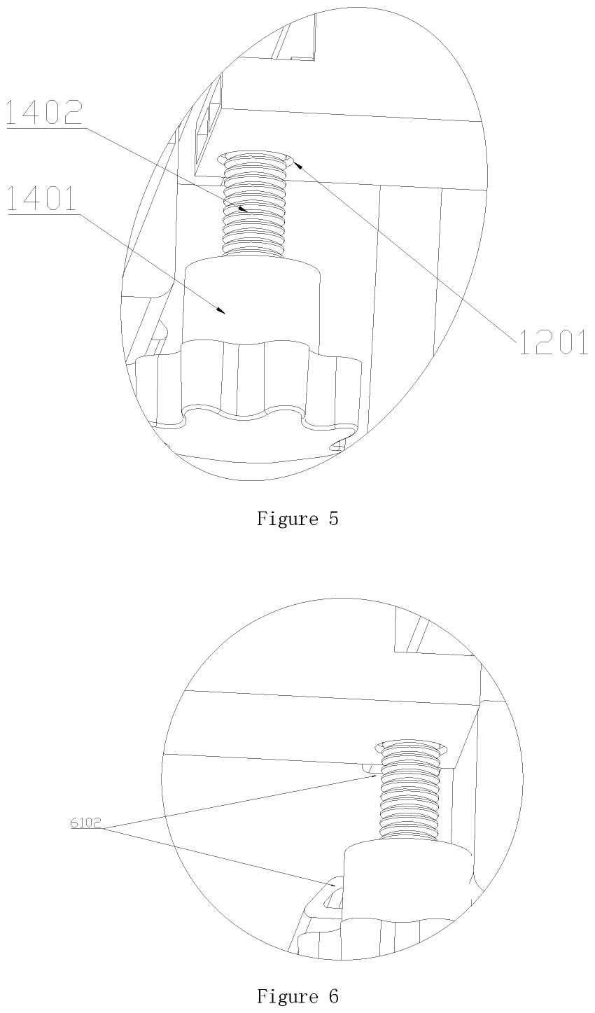

As shown in FIGS. 1-5, an embedded hard cover includes a front bar system 1, an intermediate rotating shaft system, a rear bar system 4, a side bar system 5 and a guide rail 61, the front bar system 1, the intermediate rotating shaft system, and the rear bar system 4 forming a transverse frame, the side rail system 5 forming a longitudinal frame, both the longitudinal frame and the transverse frame are connected to the car body by the guide rail 61.

The front bar system 1 includes a front bar assembly and a front bar plum nut 14, the front bar assembly is provided with a fixing hole 1201, the front bar plum nut 14 passes through the fixing hole 1201 to connect the front bar assembly with the guide rail 61.

The stability of the front bar system 1 is ensured by providing the fixing holes 1201 in the front bar system 1 and connecting the front bar system 1 to the guide rail 61 by utilizing the front bar plum nut 14 to pass through the fixing holes 1201.

### Embodiment 2

On the basis of embodiment 1, the guide rail 61 includes a blocking surface 6101, the front bar plum nut 14 includes a plum shank 1401 and a threaded rod 1402, the threaded rod 1402 passes through the fixing holes 1201 and tightens against the blocking surface 6101.

By providing the blocking surface 6101 at the guide rail 61 for tightening the front bar plum nut 14 against it for limiting, it is possible to ensure that sufficient support is provided to the front bar system 1.

### Embodiment 3

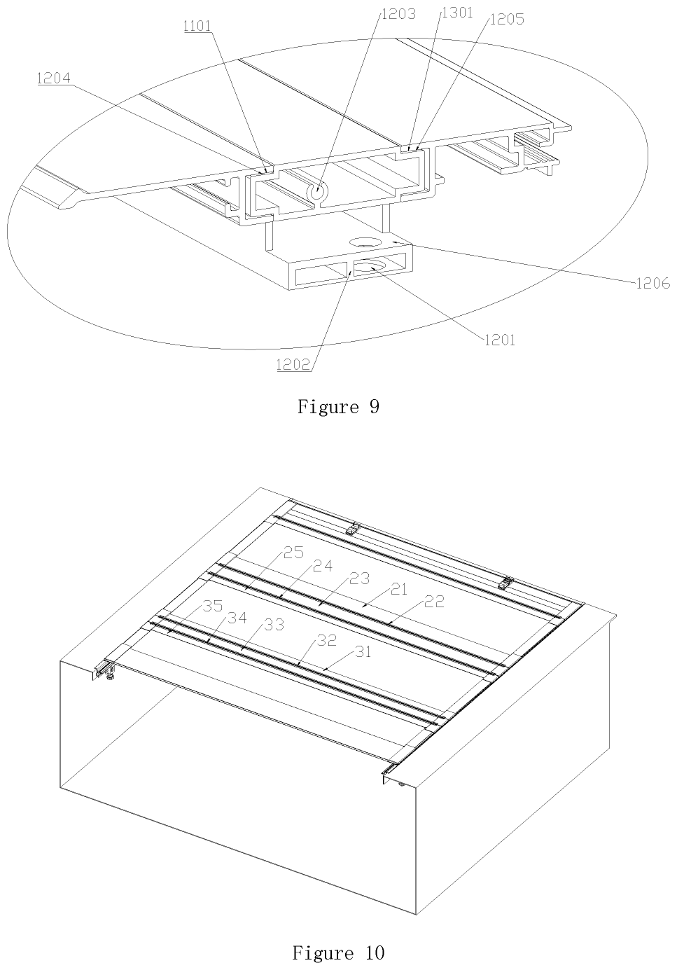

On the basis of Embodiment 2, as shown in FIGS. 6, 8 and 9, the front bar assembly includes a first front bar 11, a second front bar 12 and a third front bar 13, both the first front bar 11 and the third front bar 13 are connected to the second front bar 12, the second front bar 12 is provided with a limiting portion 1207, the fixing holes 1201 are provided in the limiting portion 1207.

The guide rail 61 is provided with a guide rail notch 6102, the guide rail notch 6102 is used to pass through the limiting portion 1207.

During installation, the limiting portion 1207 needs to be set on the lower side of the guide rail 61 before the blocking surface 6101 of the guide rail 61 can be tightened against the front bar plum nut 14, therefore the guide rail notch 6102 is provided to enable the limiting portion 1207 to be extended into the lower side of the guide rail 61, which facilitates the fixing of the front bar system 1.

The first front bar 11 is provided with a first gluing surface 1101, the second front bar 12 is provided with a second gluing surface 1204 and a third gluing surface 1205, the third front bar 13 is provided with a fourth gluing surface 1301, the first gluing surface 1101 is glued to the second gluing surface 1204, the third gluing surface 1205 is glued to the fourth gluing surface 1301.

By setting the gluing surface, the first front bar 11, the second front bar 12 and the third front bar 13 are designed as a split structure, which is convenient for transportation and manufacture, after that the first front bar 11, the second front bar 12 and the third front bar 13 are connected as a whole, which makes a better stabilization of the whole front bar system 1.

The second front bar 12 is provided with a mounting hole 1203, the limiting portion 1207 is provided with a reinforcing bar 1202.

The mounting hole 1203 is provided for connecting the side joints, the reinforcing bar 1202 is provided to increase the strength of the clamping surface 1206.

### Embodiment 4

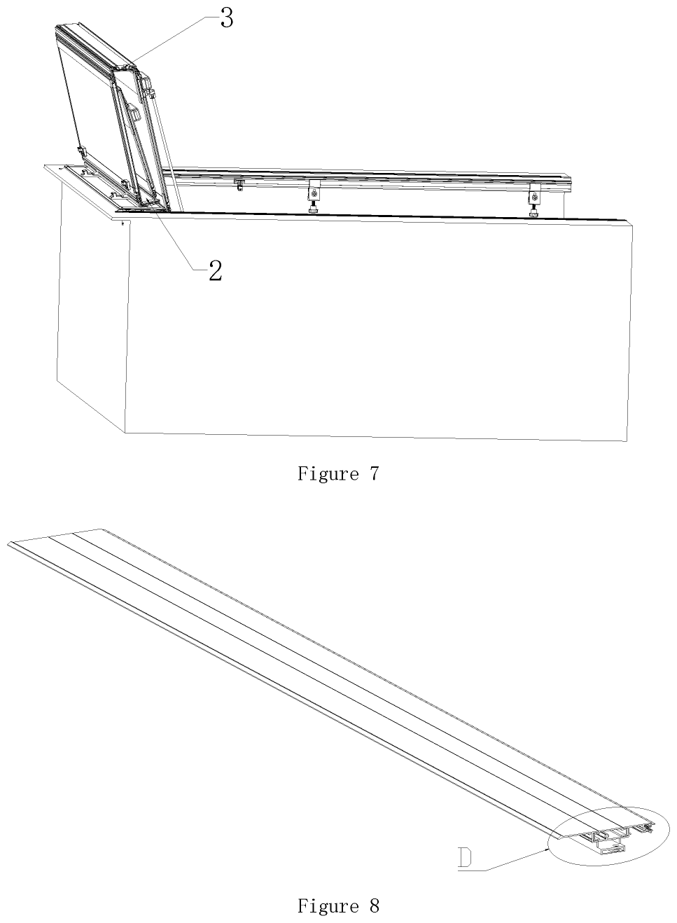

On the basis of embodiment 3, as shown in FIGS. 7 and 10, the intermediate rotating shaft system includes a first intermediate rotating shaft system 2 and a second intermediate rotating shaft system 3, the first intermediate rotating shaft system 2 and the second intermediate rotating shaft system 3 are of equal width.

The first intermediate rotating shaft system 2 includes a first left rod 21, a first left rubber strip 22, a first intermediate rod 23, a first right rubber strip 24 and a first right rod 25, the first left rubber strip 22 is arranged between the first left rod 21 and the first intermediate rod 23, the first right rubber strip 24 is arranged between the first right rod 25 and the first intermediate rod 23.

The second intermediate rotating shaft system 3 includes a second left rod 31, a second left rubber strip 32, a second intermediate rod 33, a second right rubber strip 34 and a second right rod 35, the second left rubber strip 32 is arranged between the second left rod 31 and the second intermediate rod 33, the second right rubber strip 34 is arranged between the second right rod 35 and the second intermediate rod 33.

### Specific Working Method

During installation, the limiting portion 1207 is first passed through the rail notch 6102, and then moved to an appropriate position along the rail 61, and then the threaded rod 1402 of the front bar plum nut 14 is passed through the fixing hole 1201, and the threaded rod 1402 is turned by turning the plum shank 1401 so that the threaded rod 1402 is tightened against the blocking surface 6101, to complete the positioning of the second front bar 12, next, the first front bar 11 and the third front bar 13 are glued at the two ends of the second front bar 12, and finally connecting the side joints at the ends.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. An embedded hard cover, wherein, it includes a front bar system (1), an intermediate rotating shaft system, a rear bar system (4), a side rail system (5) and a guide rail (61), the front bar system (1), the intermediate rotating shaft system and the rear bar system (4) forming a transversal frame, the side rail system (5) forming a longitudinal frame, both the longitudinal and transversal frames are connected to the car body by a guide rail (61).
The front bar system (1) includes a front bar assembly and a front bar plum nut (14), the front bar assembly is provided with a fixing hole (1201), the front bar plum nut (14) passes through the fixing hole (1201) to connect the front bar assembly with the guide rail (61).

2. An embedded hard cover according to claim 1, wherein, the guide rail (61) includes a blocking surface (6101), the front bar plum nut (14) includes a plum shank (1401) and a threaded rod (1402), the threaded rod (1402) passes through the fixing holes (1201) and tightens against the blocking surface (6101).

3. An embedded hard cover according to claim 1, wherein: the front bar assembly includes a first front bar (11), a second front bar (12) and a third front bar (13), both the first front bar (11) and the third front bar (13) are connected to the second front bar (12), the second front bar (12) is provided with a limiting portion (1207), the fixing holes (1201) are provided in the limiting portion (1207);
The guide rail (61) is provided with a guide rail notch (6102), the guide rail notch (6102) is used to pass through the limiting portion (1207).

4. An embedded hard cover according to claim 1, wherein: the first front bar (11) is provided with a first gluing surface (1101), the second front bar (12) is provided with a second gluing surface (1204) and a third gluing surface (1205), the third front bar (13) is provided with a fourth gluing surface (1301), the first gluing surface (1101) is glued to the second gluing surface (1204), the third gluing surface (1205) is glued to the fourth gluing surface (1301).

5. An embedded hard cover according to claim 1, wherein, the second front bar (12) is provided with a mounting hole (1203), the limiting portion (1207) is provided with a reinforcing bar (1202).

6. An embedded hard cover according to claim 1, wherein, the intermediate rotating shaft system includes a first intermediate rotating shaft system (2) and a second intermediate rotating shaft system (3), the first intermediate rotating shaft system (2) and second intermediate rotating shaft system (3) are of equal width.
The first intermediate rotating shaft system (2) includes a first left rod (21), a first left rubber strip (22), a first intermediate rod (23), a first right rubber strip (24) and a first right rod (25), the first left rubber strip (22) is located between the first left rod (21) and the first intermediate rod (23), the first right rubber strip (24) is located between the first right rod (25) and the first intermediate rod (23).
The second intermediate rotating shaft system (3) includes a second left rod (31), a second left rubber strip (32), a second intermediate rod (33), a second right rubber strip (34) and a second right rod (35), the second left rubber strip (32) is placed between the second left rod (31) and the second intermediate rod (33), the second right rubber strip (34) is placed between the second right rod (35) and the second intermediate rod (33).
